(19) United States
(12) Patent Application Publication
(10) Pub. No.: US 2006/0184980 A1
(43) Pub. Date: Aug. 17, 2006

(54) Method of enabling an application program running on an electronic device to provide media manipulation capabilities

(76) Inventor: David John Cole, Cambridge (GB)

Correspondence Address: SYNNESTVEDT LECHNER & WOODBRIDGE LLP, P O BOX 592, PRINCETON, NJ, 08542-0592, US

(21) Appl. No.: 10/552,639

(22) PCT Filed: Jan. 27, 2004
(86) PCT No.: PCT/GB04/00305

§ 371 Date: Oct. 7, 2005

(30) Foreign Application Priority Data
Apr. 7, 2003 (GB) 0307884.7
Nov. 18, 2003 (GB) 0326791.1

(51) Int. Cl. H04N 7/173; G06F 13/00; G06F 3/00; H04N 5/445

(52) U.S. Cl. 725/88; 725/37; 725/100; 725/102

(57) ABSTRACT

Conventionally, media manipulation tools, such as tools for editing video, are an integral part of a video editing application. But with the present invention, these tools can be shared by any application that can generate a video window in which video can be played back Hence, a conventional media player can now include video editing etc. functionality. Even more power-fully, any other application that can generate a video window, such as a presentation program, can now also be extended to include media manipulation tools.

### TECHNICAL FIELD

This invention relates to a method of enabling an application program running on an electronic device to provide media manipulation capabilities. An example is enabling a media player program to include video editing functionality.

### BACKGROUND ART

Application software for editing digital video is an extremely sophisticated and powerful tool because it is primarily designed for, and sold to, the video professional. Such an individual requires access to many complex functions and is prepared to invest time and effort in learning to become skilled in their use. Historically, the terminology and conventions of Digital Editing have evolved from a traditional film editing environment where rushes are cut and spliced together to tell a story or follow a script. As digital mixer technology advanced new techniques were combined with these conventional methods to form the early pioneering software based digital editors.

To the video or film professional, editing is second nature and the complexities of a time-based media go unnoticed since, having already grasped concepts and learned processes, they are able to concentrate on the nuances of different editing packages, of which there are many.

Conventionally these packages, through the use of a Graphical User Interface (GUI), attempt to provide an abstraction of the media in terms of many separate tracks of video and audio. These are represented on the output device in symbolic fashion and provision is made for interacting with these representations using an input device such as a mouse. Typically, the purpose is to create a new piece of media as an output file, composed by assembling clips or segments of video and audio along a timeline that represents the temporal ordering of frames. Special effects such as wipes and fades can be incorporated, transparent overlays can be added, colour and contrast can be adjusted. The list of manipulations made possible by such tools is very long indeed. A typical system is described in, for example, Foreman; Kevin J., et. al, “Graphical user interface for a video editing system”, U.S. Pat. No. 6,469,711.

It is possible, however, that an individual who is a consumer of media, rather than a producer, may need to perform a simple editing operation on a media file in order to accomplish their primary task; for example to give a multi-media presentation. In this case, such tools have their drawbacks. They may be too expensive to justify individually, or to have enough of in order to be available when or where needed. The limited amount of use and the small fraction of the capabilities used in such situations may make them uneconomic. The steep learning curve associated with such tools may mean that an inappropriate amount of effort is expended on something that is not the primary occupation or concern of the tool user. For occasional or infrequent use, there will be reluctance on the part of any user repeatedly to switch environments or learn and relearn new tools to perform simple last minute tasks.

This situation parallels previous well-known situations where improvements in the availability, usability and price/performance ratio of consumer IT equipment, has caused a significant reappraisal of what is possible and a change in behaviour to exploit new possibilities. For example, the production of high-quality printed documents was once the province of highly skilled people using expensive and specialised equipment. Now anybody with a need to produce such a document, who has access to a computer and a word-processing program, can do so. A similar shift in paradigm may happen with Digital Video Editing, where there is a need for highly accessible and usable tools that focus on the needs of a new generation of user, and that do not necessarily try to recreate the feel of a traditional video editing environment.

It is challenging to design such tools for a new generation of digital media professionals, who may well be extremely familiar with the manipulation of documents of various kinds through a computer's GUI, but be completely unfamiliar with the characteristics of time-based media. The tools need not supercede long established and specialised tools used by trained professionals but, rather, provide a bridge in order that new users may be as comfortable working with time based media as they are working with documents.

Conventionally, video editors are structured as specialised ‘monolithic’ applications. Current software technology, however, is well capable of adding sophisticated editing functions to unrelated applications through the use of software ‘plug-ins’. The Microsoft® DirectShow® Editing Services is an application programming interface (API) that is built on top of Microsoft® DirectShow® that allows video editing capabilities to be added to applications. In this example, ‘filters’, implemented as Common Object Modules that support the DirectShow interface, are created and inter-connected to form ‘filter graphs’. As another example, the QuickTime track based architecture is the foundation of many modern day editors such as Adobe Premiere®. It offers embedded API based access, resident below the application layer that provides for simple track manipulation. However, these plug-ins are deployed primarily in applications that are designed for video editing or playback, and not other kinds of applications, such as presentation/slide show applications, web page authoring applications etc. Further, these plug-ins do not provide a consistent GUI across the different applications in which they can be deployed.

### SUMMARY OF THE INVENTION

In a first aspect, there is a method of enabling an application program running on an electronic device to manipulate media, comprising the step of generating and displaying a video window associated with the application program;

characterized in that media manipulation tools, enabling an end-user to manipulate the media, are generated and deployed for any application program running on the device for which an associated video window can be generated.

Conventionally, media manipulation tools, such as tools for editing video, are an integral part of a video editing application. But with the present invention, these tools can be shared by any application that can generate a video window in which video can be played back. Hence, a conventional media player can now include video editing etc. functionality. In one implementation, the capability for media-manipulation is added to software media players, such that this capability is intrinsic to the media player; a set of media manipulation tools are provided that appear intrinsic to the media player and that ensure that consistent behavioural, visual and-functional aspects are maintained between media player applications. Even more powerfully, any other application that can generate a video window, such as a presentation program, can now also be extended to include media manipulation tools. These tools are preferably a simplified sub-set of the tools available in a proper video editing program and may enable the following operations to be performed:
editing, trimming; annotating, seeking, selecting effects; transitions; re-ordering;
publishing; still extraction, vector graphic alteration; create storyboard.

In an implementation, user interface components (e.g. controls) associated with the media manipulation tools are rendered in or adjacent to the video window. Further, the visual appearance and/or function of some or all elements of the media manipulation tools are the same across all the application programs for which an associated video window can be generated.

The media manipulation tools may also make use of a streaming media architecture that is common across all of the application programs. Further, the media manipulation tools may be generated and deployed by a system that comprises:
(a) a device independent media manipulation layer; and
(b) a device independent insulation layer below the media manipulation layer to insulate the media manipulation layer from a device specific media handling or streaming media subsystem;
(c) a device GUI abstraction layer above the media manipulation layer to insulate the media manipulation layer from the display characteristics of the specific device.

In a second aspect, there is a device programmed with software that, when running enables an application program to manipulate media, the software being operable to generate and display a video window associated with the application program; the device being programmed with further software that deploys media manipulation tools enabling an end-user to manipulate the media;

characterized in that the further software is operable to deploy media manipulation tools for any application program running on the device for which an associated video window can be generated.

Briefly, an implementation of the invention works as follows. A plug-in module is loaded into the computer's memory to provide the specific functionality required. This software module has interfaces to a media delivery, or streaming media subsystem, such as the Microsoft® DirectShow® architecture for the Microsoft® Windows® platform that provides services for streaming, buffering, synchronisation, decoding and rendering of video and audio. Media is streamed into a local cache that provides for fine-grain scrubbing ‘jog’ and ‘looping’ of short sections around ‘in’ and ‘out’ points. A set of instructions is devised for each piece of media and its interaction with a timeline. Specific elements are constructed in memory to process these instructions and subsequently handle the media in a suitable form, as compatible with the media play architecture in operation. New and modified elements may be constructed and reconstructed as required: each element may process, but is not limited to, a single set of instructions or piece of media.

The functionality provided by this software module comprises:
(a) Graphics rendering to allow the combination and/or overlay of graphical data for the GUI with pixels that are decoded from the video part of the media file and rendered into the video window area on the screen.
(b) A cache for portions of the media file in the memory of the client machine.
(c) A state machine, whose transitions guide a user through a sequence of interactions with a graphical user interface (GUI).
(d) GUI that implements visual feedback of the current state to the user.
(e) GUI that implements a visual metaphor that provides the user with an intuitive understanding of the operation of the interface.
(f) An exporter for the persistence of the chosen manipulations, for example; to “Save” the processed media to memory creating a new media object or create a new set of instructions that describes the precise operation required to effect the manipulations for playback, including but not limited to, such instruction as references to sections within a remote piece of media.
(g) GUI that allows labels of various types to be added to significant parts of the media file in order to identify them as such and/or enable seeking to these significant parts.
(h) GUI that implements the ability to read a description file(s) and construct playback in accordance with set instructions, or write such instructions from a current playback.

In this embodiment of the invention, the GUI is provided by modules within the software framework that implements the media player, by the addition of visible user interface components (buttons, text boxes, etc.) associated with the media manipulation tools, either overlaid or actually burnt into the rendered video window (i.e. the pixels written to the framestore by the video renderer are overwritten) or adjacent to the video window, or somewhere else within an application window of the application that either is itself the media player program or has invoked the media player program. In the Windows Media™ architecture, where software filter graph components are linked together to implement a media player, this functionality may be added into a video renderer filter or an overlay filter.

The GUI may be provided by software modules, other than those embedded within the media player framework, such as ActiveX controls.

Elements may be exchanged between instances of a media player.

In the preferred embodiment, the Windows Media™ environment is employed such that one instance of the player may be used to manage the “master” timeline, while another allows clips to be trimmed to the desired length and then dragged and dropped into the “master” player instance. At this time the recipient instance may chose to combine the filter graph for the new piece of media with those already in existence, or it may chose to reconstruct a new filter graph based on the complexity and required interaction of the current timeline objects.

A process flow may be provided that provides for untrained users to achieve their goal with minimum effort, and distraction from their primary task.

State machines may help walk the users through operations to avoid mistakes and distil the complexity of editing into bounded and easy to understand processes. Visual and tactile feedback will provide rapid confidence in the task and aid progress; e.g. to slim down a media object, the user will select a “Start Here” in point and be guided towards a “Stop Here” out point.

Effective confirmation methods are employed to inform and protect the actions of the user and visual metaphors will be provided from the embedded editor level to identify nodes of the current state machine. For example, the video window may show a filmstrip with the current frame highlighted, with subsequent frames normal, and with the cropped frames indicated with a strike out marker.

Meta-data in the media file (mapped to labels in the media file) may be recognised by a software decoder component in the system and used as a stream of control information that is used to assist editing operations, e.g. by mapping the meta-data contained in the media file to labels.

The meta-data may include but is not limited to:
(a) Timecode,
(b) Closed caption
(c) Edit points used during the creation of the media,
(d) Format-dependent properties such as GOP boundaries in MPEG,
(e) Data generated as a result of post-processing such as shot change information;
(f) story boarding.

The control information identifies significant points in the media and triggers events that cause instructional or informative information to be displayed. For example, dialogue boxes may pop up during playback with labels such as “Start Here” (IN) or “Stop Here” (OUT). Actions can be initiated too; e.g. hold frames for a given duration, loop and messaging.

The media player with intrinsic media-manipulation capability may run on a number of platforms of different types, configurations and capabilities. For example, it may run on:
PCs and workstations;
set-top boxes (cable or satellite television decoders);
Personal Video Recorder (PVRs);
mobile devices including Personal Digital Assistants PDAs; and
mobile phones.

The visual appearance of the GUI may be sensitive to the context in which the user of the system is working in order that the tools may be non-intrusive (absent or minimized) when not needed, but available when called for. For example, the visibility of the GUI may be dependent on whether or not the cursor falls outside or inside the video window. If the cursor is outside the window the controls are invisible and disabled; if the cursor is inside the window the controls are visible and enabled.

### BRIEF DESCRIPTION OF THE DRAWINGS

The present invention will be described with reference to the accompanying drawings, in which:

FIG. 1 shows the video window of a standard media player;

FIGS. 2-14 show the same player as shown in FIG. 1 but with the intrinsic editing GUI, defined by the present invention, activated and the controls visible within the video window;

FIG. 15 shows the media player with the intrinsic editing GUI, defined by the present invention, together with a dialogue box allowing the user to specify where to save a newly created video clip;

FIGS. 16 and 17 show the process of adding a bookmark to the media using the system of the present invention;

FIG. 18 shows the media player once more with intrinsic editing GUI enabled and visible, but this time embedded within a Microsoft® Powerpoint™ page;

FIG. 19 shows the player once more with GUI enabled and visible but this time embedded within a standard web page;

FIG. 20 shows the typical content of the SMIL (Synchronous Multimedia Interchange Language) text file that is generated as a result of the editing operation illustrated in FIGS. 10 to 15.

FIG. 21 is a schematic of the architecture of an implementation of the present invention;

FIG. 22 illustrates the main processing elements and the data flow between them of this implementation;

FIG. 23 illustrates the interactions that occur when a typical seek operation is performed using this implementation; and

FIG. 24 shows the state machine that describes the process for editing media to generate a new clip as illustrated in FIGS. 10 to 15.

### DETAILED DESCRIPTION

1. Background

Video and audio goes to all kinds of devices now, ranging from high-resolution workstations to mobiles. Content must be created somehow, and a small number of professional users employ sophisticated tools for creating media content. For the rest of us digital video means simply hitting the ‘play’ button and watching the results.

For ordinary users (i.e. not video professionals) to accept, appreciate and really want digital media content, they need also to become stakeholders in its creation. Unfortunately, the highly sophisticated and expensive tools that are used for professional content creation are not appropriate for the average consumer of media—they are either too complex to use, too expensive, or both (and they are unlikely to be present on the hard disc when needed).

The conventional view of being a media ‘user’ is that, by default, you have a media player that allows passive, linear viewing. If you want to edit your own content, you buy a video editor; if you wish to extract and colour-balance or otherwise enhance stills, you need photo editing software. Many other types of manipulation may occasionally be required and, for each, another application needs to be purchased and the user interface and methodology understood. More often than not, the tool provides much more sophistication and many more capabilities than the ordinary user will ever need, or be capable of using.

2. Overview of Arthur

If you have access to a piece of media, you can view it using a media player application: with the present invention, by default, you also have access to the means to interact with it and change it—i.e. the present invention provides pervasive availability of media manipulation tools, whenever an application can display a video window in which video can play, irrespective of the kind of application—e.g. presentation software, video media player, web design etc. This new approach is analogous to how we expect video games to behave: in order to play a game you do not expect to have to start a ‘video game application’ that allows you to choose a game and which provides a set of interactive functions. By having the game you also have the means to interact, explore and determine which of many and various paths you take to the end.

Arthur is an implementation of the present invention from IPV Limited of Cambridge, United Kingdom. Arthur puts into the hands of the user—any user—simple to use yet powerful “always available” functions which operate on the media which is currently ‘in hand’.

As noted earlier, video editors are application programs that run on high-end PCs and workstations, under desktop-oriented operating systems such as Microsoft® Windows® or Apple's Mac OSX®, often with high-resolution screens and high-bandwidth network connectivity. The viewing of media files, however, can take place on an ever-expanding list of devices with many different capabilities, such as laptops, mobile PDAs with wireless connectivity, mobile phones, set-top boxes and hard-disc based personal video recorders (PVRs). The concept of Arthur, namely media manipulation tools integrated over/into the media player component, is as relevant in these cases as it is in that of the standard PC, possibly more so since, for example, a PVR may not have a run-time environment capable of running external applications such as video editors.

These are the core attributes of the Arthur tool:
1. Simple and intuitive to use; in particular, little time and effort is required to learn enough to accomplish the task in hand.
2. Terminology and workflow consistent with a shift in convention towards action led digital media editing; e.g. ‘Jog’ to select as with modern VCR's and a simple crop ability to trim the running length of a piece of media.
3. Available whenever and wherever needed, even if the user did not foresee the need for such a tool until that need cropped up, i.e. the media manipulation capability is provided as an intrinsic part of the environment by way of any player of the media.
4. Provides a consistent interface to the user irrespective of the type of ‘container’ application it is associated with. It would look exactly the same whether incorporated into an electronic text document, a spreadsheet, or a slide presentation.
5. Persistence of modifications; e.g. the user opens a media object, or a document containing an embedded media object and expects any changes they make to persist between sessions.

Arthur is hence:
A radical alternative to the conventional “play from front-to-back” view of multimedia.
A way of raising the level of user-expectations, involvement, and interest in, multimedia.
An enhancement layer that embeds media manipulation functions over or into a media streaming subsystem.
Consistent across hardware devices.
Consistent across operating systems and platforms.
Ubiquitous; all Arthur's functions are available wherever and whenever media is used.
Extensible; new functions can be added into Arthur as they are developed.
Future-proof; a query interface allows Arthur's host to use the new features as they appear.
Equally applicable to workstations, PDAs, PVRs and mobile devices.

3.1 How Arthur Works

When networked media made its first appearance on a desktop computer, it was typically done through an application-level program that made use of some basic remote file access primitives in the operating system. The result was often slow, lumpy and unwatchable. Very quickly it was realised that, in order to present to the viewer a quality equivalent to consumer equipment such as VCRs, the real-time properties of media required a lot of serious consideration. Streaming functionality migrated downwards into the operating system services to the point where everything, from the streaming of packets of compressed data from the network, through a decompressor, up to the rendering of pixels on the screen, is handled by a media subsystem beneath the application program level.

Arthur takes this ‘downwards migration’ a stage further. Certain capabilities conventionally thought of as being part and parcel of a media content creation application can be implemented at a lower level; for example the splitting up, reordering and management of short sections of media (clips). Further, the user interface that allows interaction with these capabilities can also be implemented by a separate and unrelated layer of software. Arthur also enables a media file to be selected and played by the user, which provides instruction in the use of the media manipulation tools.

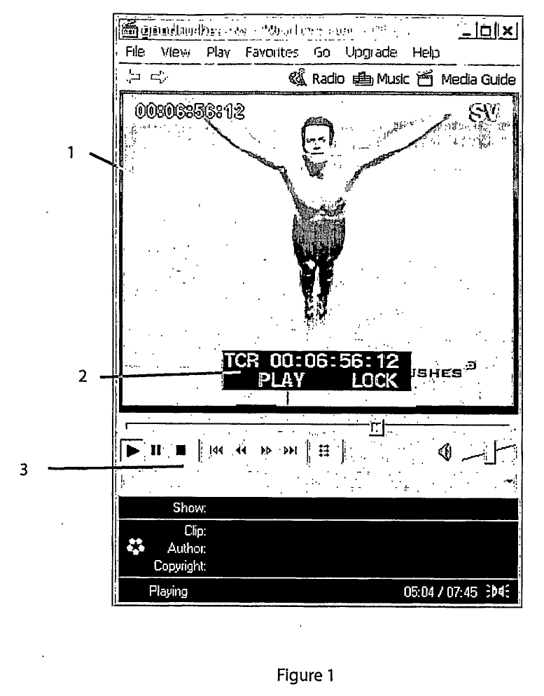

Referring now to the Figures, FIG. 1 shows the Graphical User Interface (GUI) of a standard media player The usual selection of menu bars, buttons and sliders (3) can be seen to surround the rectangular video window (1). Burnt-in timecode (i.e., characters drawn into the video memory area) are visible at the bottom of the video window (2).

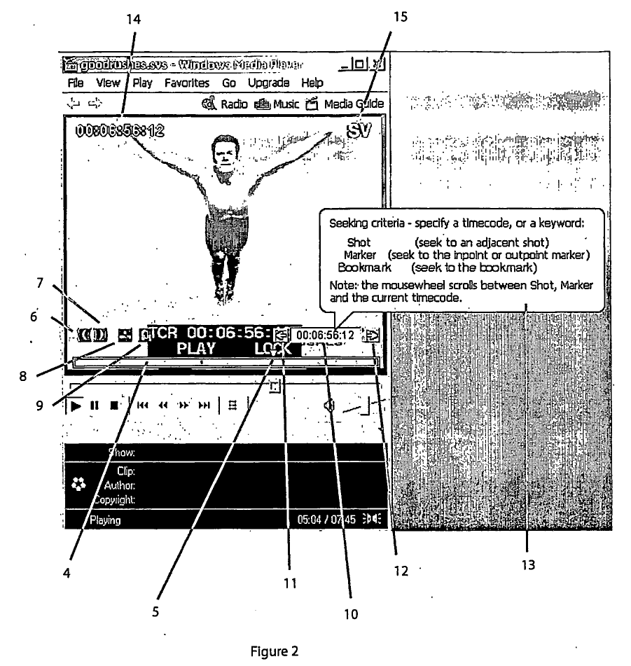

FIG. 2 shows the same player as shown in FIG. 1 but with the intrinsic editing GUI, provided by Arthur, activated and the UI components associated with the Arthur media manipulation tools (e.g. controls) visible within the video window. In this particular instance, the GUI is activated by moving the mouse pointer from the outside of the video window to an appropriate region inside. The media player can be running on a personal computer, a television decoder box, a personal video recorder, a personal digital assistant, a mobile telephone, a smartphone or a video kiosk.

At the bottom, an edit bar (4) is visible that represents the timeline of the loaded media file together with a pointer (5) that indicates the current position within the file. Above and to the left of the edit bar are buttons with left (6) and right (7) “brace” symbols for specifying “in” and “out” points, respectively. To the right of these there is a button for performing the “make new clip” operation (8), the symbol for which has a bar through it, meaning that the button is not active because no “in” and “out” points have as yet been set. Next is a button with a “book” icon (9) that is used for annotating the source media with a “bookmark”. This could be used, for example, as a tentative in or out point.

At the far right of the video window is a text box with SMP timecode visible (10), and backwards (11) and forwards (12) “seek arrow” buttons (note that it is possible for video material to contain timecodes which do not monotonically increase, so it is a legitimate operation to seek forwards to an “earlier” timecode). Typing a timecode into this box and pressing the appropriate seek button causes a seek to the frame with this timecode label. The text box is modal: by using the mouse buttons, seek criteria can be chosen from timecode, shotchange, in/out marker and bookmark. ToolTips (13) are associated with the buttons; in the figure, the ToolTip shows the available seek criteria.

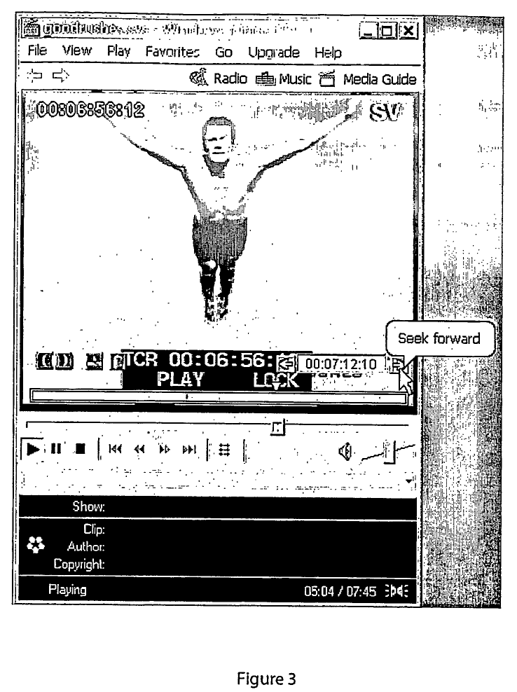

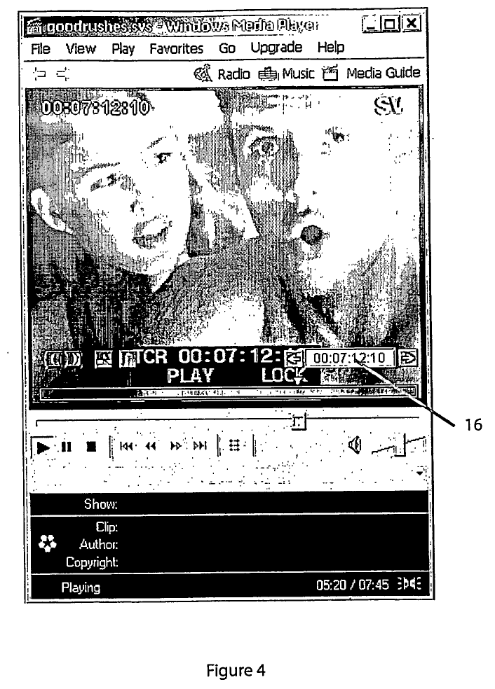

FIGS. 3 and 4 show the process of performing a seek. The user types a timecode (here: 00:07:12:10) into the text box and presses the “seek forward” button. FIG. 4 illustrates that the video has moved to the requested frame and the text is rendered in green (not shown) instead of black in order to indicate that the specified timecode could be found and that the operation has been successful (16).

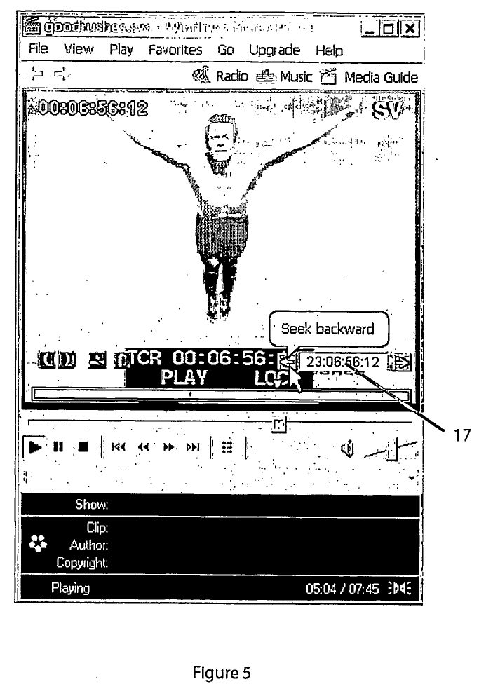

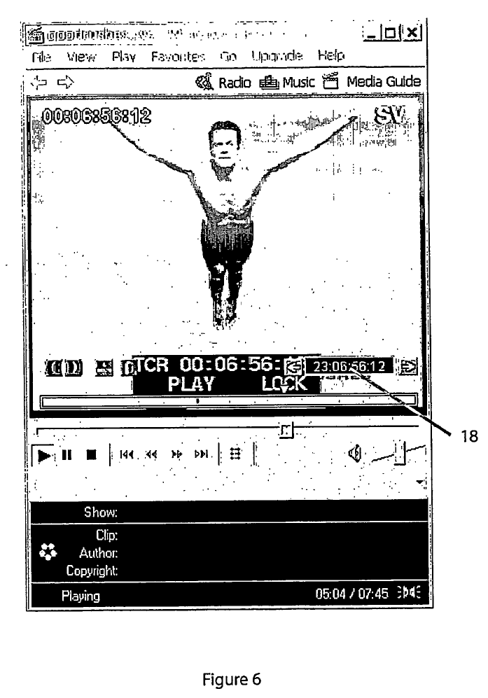

FIGS. 5 and 6 show the result of requesting a seek to a non-existent or nonsensical frame. The user types a timecode (17) into the text box and presses the “seek backward” button. FIG. 6 illustrates that the video has not moved to the requested frame and the text in the text box is rendered in inverse video (18) to indicate that the operation has been unsuccessful.

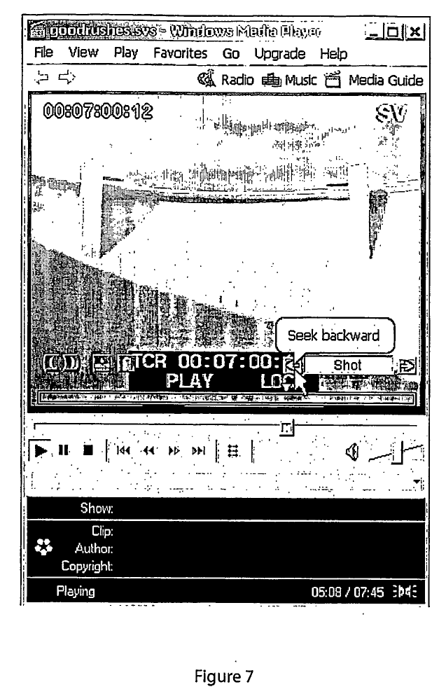

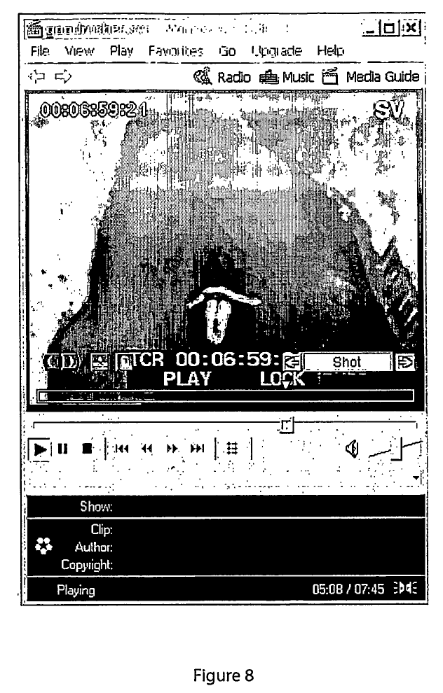

FIGS. 7 and 8 show the process of seeking to a shot change. The user changes the seek text box mode to “shot” and presses the “seek backwards” button. FIG. 8 illustrates that the video has moved to the requested frame and the text in the text box is rendered in green (instead of black) to indicate a successful operation (i.e. a shot change could be found).

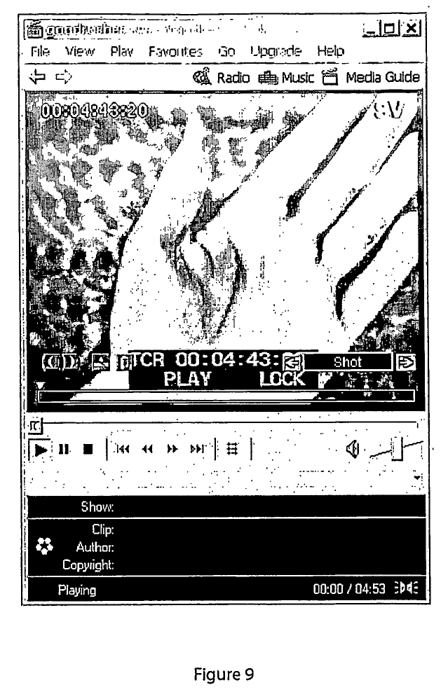

FIG. 9 shows the situation when there is no shot change available to satisfy the request. In this illustration the media is already positioned at the very first frame so the seek shot backwards operation fails, and this is signalled to the user by rendering the text in inverse video.

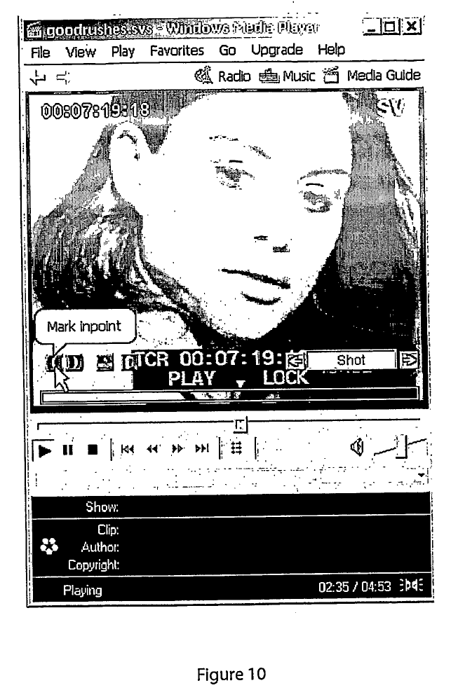

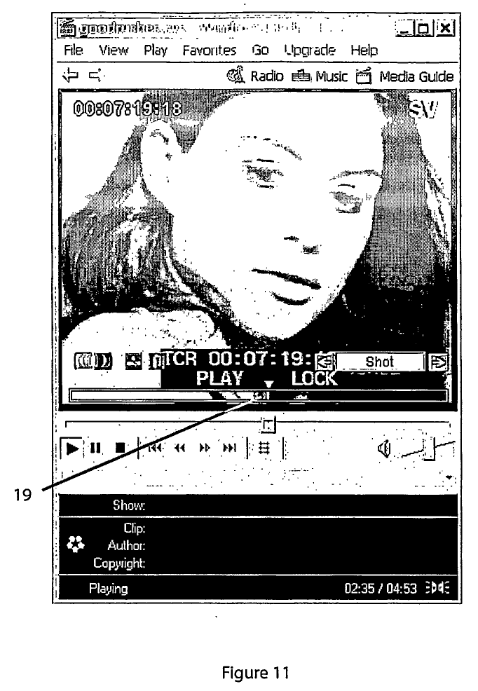

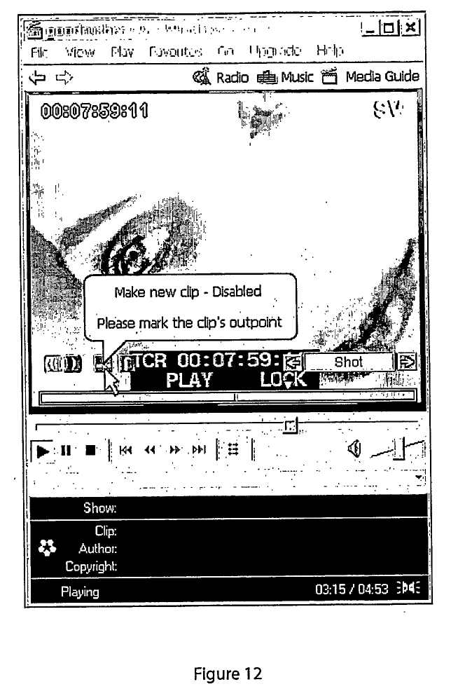

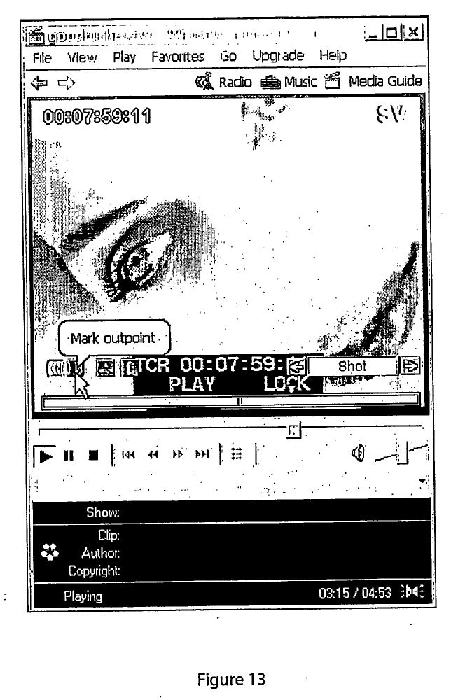

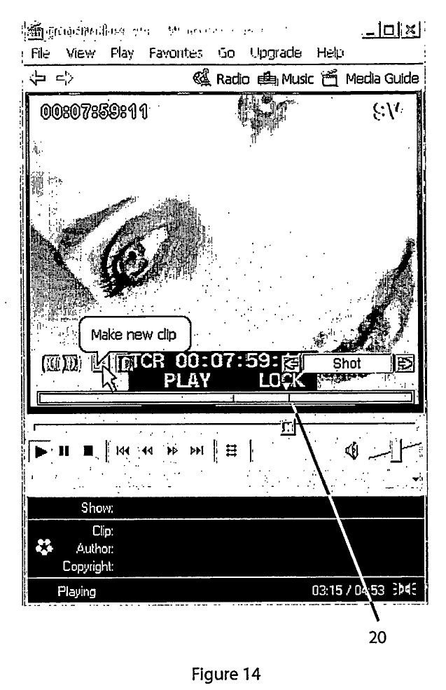

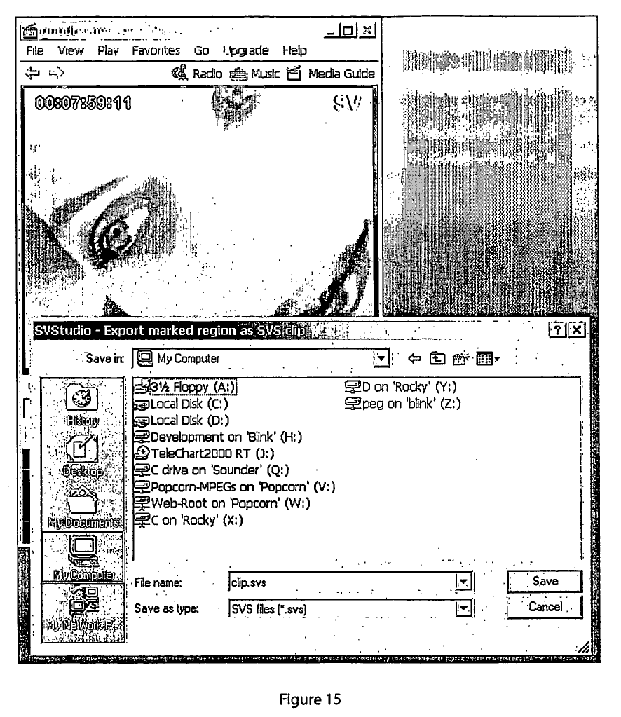

FIGS. 10 to 15 show the process of editing the media in order to produce a new, shorter, clip, from the original. FIGS. 10 and 11 illustrate the user finding the in-point (the first frame of the new clip) and pressing the “mark in-point” button, which puts a green “in-point” handle into the timeline (19). FIG. 12 shows that the “make new clip” button remains disabled (because there is no out-point yet) and the user is informed of this via a tool-tip: “Make new clip—Disabled Please mark the clip's output”. FIGS. 13 and 14 illustrate the user marking the out-point, which places a red “out-point” handle in the timeline (20), and pressing the “make new clip” button (which is now enabled). The user is then presented (FIG. 15) with a dialogue box to specify where to save the new clip.

The in-point and out-point marker buttons cause, respectively, green and red handles to appear on the timeline which delineate the new clip, and which may be dragged to modify the region of video selected as the target of the “take clip” operation.

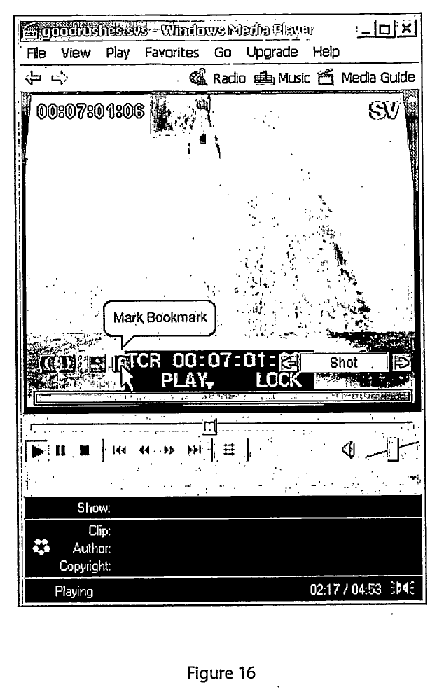

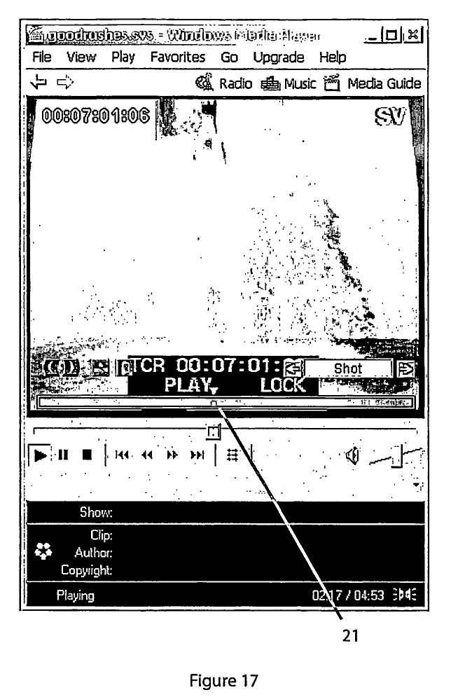

FIGS. 16 and 17 show the process of annotation by adding a bookmark to the media. The user moves to the desired frame and presses the “bookmark” button. When the button is pressed a marker is created and inserted as meta-data in the media and its position is signified by a small symbol on the timeline (21).

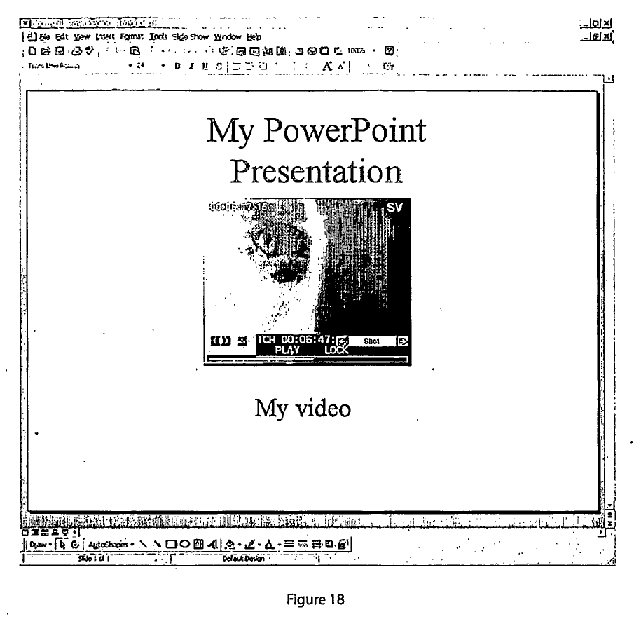

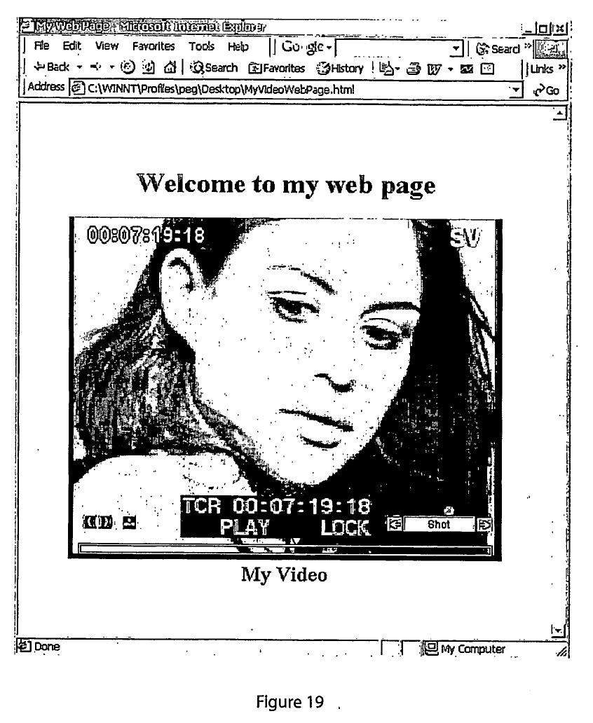

The invention exploits the fact that there is a wide spectrum of application programs that can incorporate video and audio by making use of an underlying streaming media architecture. These include straightforward media players, document preparation programs, help systems, web browsers, slide preparation programs, electronic mail, interactive learning applications, games, security and surveillance systems, collaborative systems, computer-aided design and so on. In each and every case where such an application uses the streaming media architecture, the media manipulation capability of the present invention is also available to the application. FIGS. 18 and 19 underline this point, as described below.

FIG. 18 shows the player once more with GUI enabled and visible but this time embedded within a Microsoft® Powerpoint™ page.

FIG. 19 shows the player once more with GUI enabled and visible but this time embedded within a standard web page.

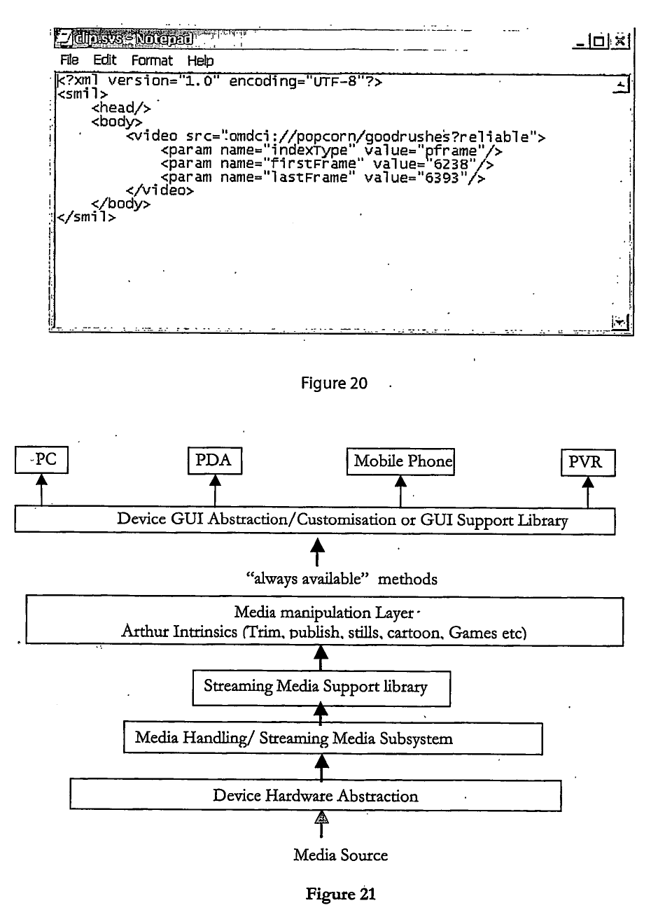

FIG. 20 shows the typical content of the SMIL (Synchronous Multimedia Interchange Language) text file that is generated as a result of the editing operation illustrated in FIGS. 10 to 15.

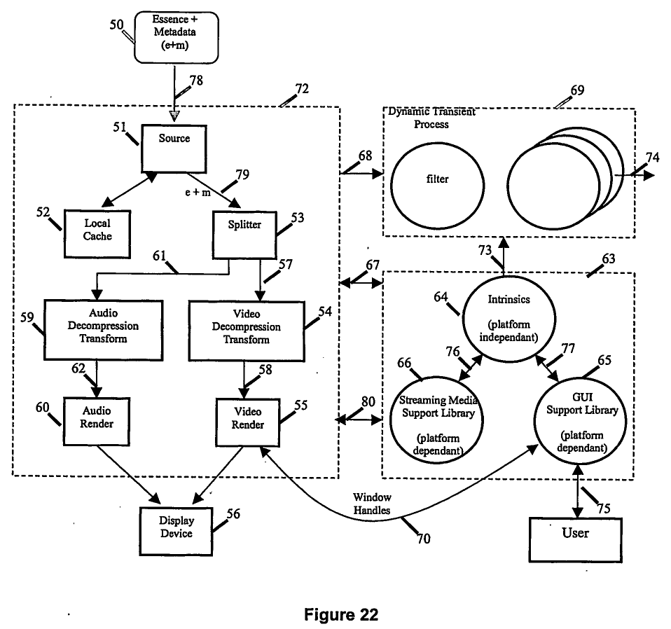

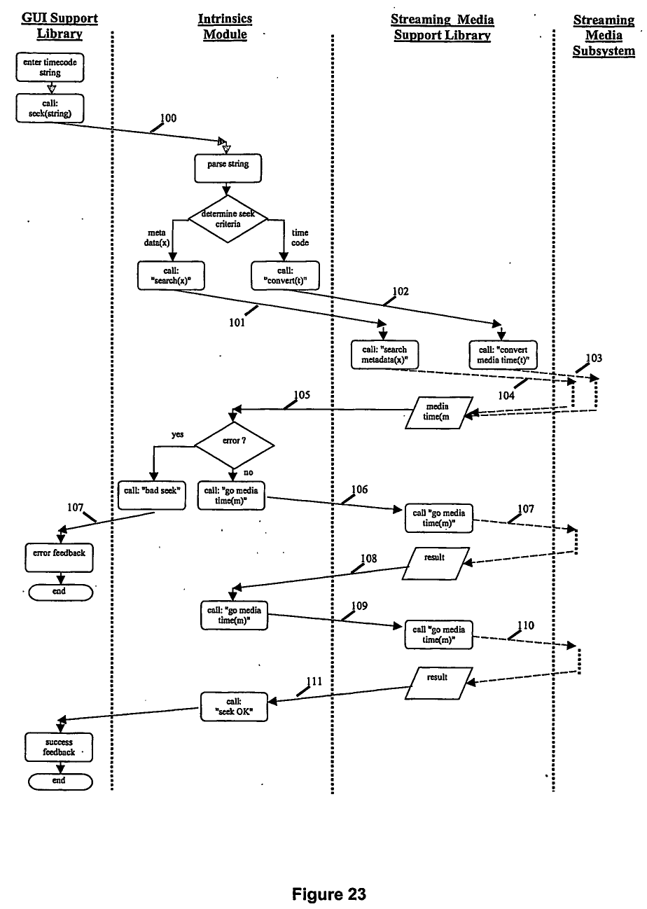

FIG. 21 shows the basic Arthur architecture. At the bottom level is a ‘Device Hardware Abstraction’ layer; this layer is optional but especially useful where the device is a mobile telephone or other kind of device running an OS that provides only limited hardware abstraction. Above the optional Device Hardware Abstraction layer sits a ‘Media Handling’ layer for network streaming, audio and video splitting, decoding and synchronisation. This is equivalent to the Filtergraph manager of FIG. 22 and the Streaming Media Subsystem of FIG. 23. Above the Media Handling layer is a Streaming Media Support Library; and above that the ‘Intrinsics’ layer. The Streaming Media Support Library insulates the Intrinsics layer from needing to know about the specifics of the Media Handling layer that is actually deployed.

The ‘Intrinsics’ layer itself presents a model of the media currently in hand as an object upon which a set of methods are defined. These methods are associated with specific operations on media, called Intrinsics. Intrinsics define the novel operations that Arthur offers up to the user interface. They have a consistent behaviour across every Arthur implementation.

The diversity of devices in which Arthur can be deployed means that a way of adapting their different I/O capabilities must be provided. This is the job of the Device GUI Abstraction layer (equivalent to the GUI Support Library in FIGS. 22 and 23). This is a device-specific layer of code that maps the virtual method interface of the Arthur Intrinsics into the physical interface (e.g the specific display characteristics) provided by the device. In addition to specifying how the interface works for a particular hardware device, this allows vendor-specific customisation. Hence, more generally, in Arthur, the media manipulation tools are deployed by a computer based system that comprises a device GUI abstraction layer and an underlying, separate media handling layer and/or media manipulation layer; the separation enabling different devices to be deployed with different kinds of GUI abstraction layers so that the UI components associated with the media manipulation tools appear different on these different devices, but the underlying media handling and/or media manipulation layers are common: vendor specific customization is hence greatly facilitated.

Returning to the Intrinsics, these include the following operations:

Trim Edit

This allows simple cuts of the currently viewed media to be made in order to trim unwanted material from a clip, perhaps prior to sending the clip as an MMS video message.

Intelligent Seek

Meta-data encoded into the media stream describes time-indexed ‘features’ or ‘events’ that the user has registered an interest in and which are used as bookmarks in the trim-editing intrinsic. These events may be simple shot-changes or high-level features such as ‘here is the next goal”.

Publish

This enables the current media clip to be posted to a web page, for example, to update a ‘video web log’. If the user hasn't specified a personal URL, the system (external to Arthur) should provide a ‘default’ such that the media is posted and a URL is returned to the user.

Stills

The current video clip can be reviewed and the ‘best’ frame selected for use as a still. Simple colour balance, cropping and text annotation functions are provided.

Cartoon

A still image can be simplified and processed into a vector graphic description. As well as providing considerable data compression the resulting ‘cartoon’—like representation may convey information more clearly than a very small and indistinct bit-map image. Reference may be made to EP 1368972, the content of which is incorporated into this disclosure.

Pervasive Gaming

This bundles together methods from all the other intrinsics for use by application-level programs that implement games, and in particular, pervasive, multi-player games in which video, stills and cartoons are gaming elements.

3.2 Media Manipulation Architecture

Arthur utilises the ‘filtergraph’ architecture for Microsoft® Windows® in the Media Handling/Streaming Media Subsystem. Other streaming media subsystems may also readily be employed. A filtergraph streams multimedia data through a group of connected processing elements of different types called filters. These filters perform operations such as inputting into the filter graph the data from a source, transforming it, and rendering it into video memory for display. A transform filter, in general, takes media data, processes it, and then passes it along, so transform filters may be introduced into the graph used to perform other operations on the media. In the case of video this may include processing in order to generate shot-change, storyboard, and other types of video description information. In the case of audio, this may include processing in order to generate silence-period, and other types of audio description information.

FIG. 22 illustrates the main processing elements and the data flow between them, and is described in the following.

The Filtergraph manager (72) refers to the standard media handling streaming media architecture for Microsoft® Windows®. Media data (50) comprising essence (video and audio) and meta-data (timecode and similar time-synchronised annotation) is introduced into the Filtergraph through the Source Filter (51) and is cached locally in high-speed RAM (52). The Splitter Filter (53) demultiplexes the media into separate video (57) and audio (61) compressed streams which are decompressed by the video (54) and audio (59) decompression filters into raw video (58) and raw audio (62) streams. The Video Render (55) and Audio Render (60) Filters write these streams to the Display Device (56).

The Media Manipulation Layer (63) comprises a platform-independent ‘Intrinsics’ module (64) that contains code that implements all the behavioural aspects of the Arthur implementation, for example, the sequence of operations required to perform an edit, and the GUI interactions that are required in order to cause such an edit to happen. The Streaming Media Support Library (66) and GUI Support Library (65) modules convert the platform-independent methods and callbacks (76), (77) supported by the Intrinsics module into platform-specific API calls down to the Filtergraph Manager (80) and up to the GUI controls (75). This layer provides a path, both for user-supplied meta-data to be introduced into the Filtergraph and written into the media stream and for meta-data to be passed up into the Intrinsics module for inspection (67). The GUI Support Library obtains a handle (70) directly from the Video Render Filter in order to manage the video window.

In order that edited media may be exported from the system, the Media Manipulation Layer (63) has an interface (73) to create a new Filtergraph (69) that takes (68) the required media from the Filtergraph Manager (68) and processes it in order to produce a new physical media clip (74).

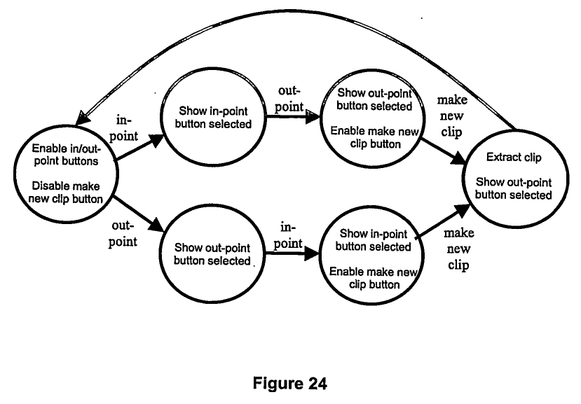

The ‘Intrinsics’ module (64) defines the behaviour of the system, in a similar manner to a conventional application program, but it is implemented at a low level as a plug-in component of the media player. It is a software module that presents a model of the media as an object upon which a set of methods are defined that govern the operations available within the system. As noted earlier, this method interface is offered downwards, to an underlying streaming media architecture or subsystem (72) via an insulation layer (the Streaming Media Support Library) that is platform dependent and insulates the platform independent Intrinsics module from having to deal with the specifics of the actual streaming media subsystem deployed. This enables alternative streaming media susbsystems (e.g. Apple Quicktime®) to be readily deployed without the need to modify the Intrinsics module. The Intrinsics module presents an upwards interface to an overlying GUI via an GUI Support Library (65); the GUI Support Library (65) is an insulation layer that is platform dependent and insulates the platform independent Intrinsics module from having to deal with specifics of the I/O for the device display. The Intrinsics module can therefore be implemented on various platforms and ensures a consistent behaviour across every implementation. As mentioned, the Intrinsics module defines a behaviour and this in turn is specified by a set of state machines, such as the one illustrated in FIG. 24. In the implementation described here the Intrinsics module converts the method invocation generated by the overlaid GUI into a sequence of activities such as media stream start, pause, and stop, that are sent to the filtergraph which then in turn calls the appropriate methods on the filters to invoke them.

Associated with the platform-independent Intrinsics Module are, as noted above, the platform-dependent “Streaming Media Support Library” and “GUI Support Library” modules. These provide the path for control information to flow between the GUI, the Intrinsics module, and the filtergraph. A path for meta-data into the filtergraph is also provided so that the user is able to annotate the media with meta-data, as in the case of adding a “bookmark” to the media.

The filters required are as follows.

The Source Filter 51 takes as input a stream 78 from a locally stored media file, or from a remote video server. The filter controls some basic functions such as frame-accurate seek. In particular it is responsible for managing streamed (rather than transaction-based) output from a video server for high performance and scalability.

The Local Cache 52 uses local random access program memory to retain a copy of the media data and, whenever possible, this is used as the source of data for the filtergraph. This ensures that small, rapid, seeks around the current frame can be carried out as quickly and smoothly as possible.

The Splitter Filter 53 demultiplexes video and audio from the media stream and is responsible for generating the media sample timestamps that the rendering filter uses for presentation purposes.

The Audio and Video Decompression Transform Filters 59, 54 decompress the encoded media into form suitable for output. The Video Decompression Transform Filter 54 also adds the ability to access meta-data that is encoded into the stream (contained in private data packets in the case of MPEG), decode it, and use it to modify the decompressed media, as described below.

The Video Render Filter 55 sends the media data to the video output hardware device.

3.3 Meta-Data, Annotation and Labelling.

The data flowing through the filtergraph consists both of ‘essence’ (video and audio) data, and of meta-data (e.g., timecode), and other time-indexed ‘features’ or ‘events’. All the filters parse the data stream looking for this meta-data and notify the Intrinsics module of its occurrence, modifying their behaviour according to whether this data is present or not. The meta-data includes, but is not limited to the following:
(a) timecode
(b) logo bit map (for example a broadcast station logo)
(c) logo marker
(d) captioning (closed caption text)
(e) shot-change
(f) video description data
(g) audio description data
(h) user-inserted bookmarks
(i) client-targeted information and advertising
(j) digital rights management data
(k) watermark data
(l) conformance data
(m) Edit-in and edit-out points
(n) GOP boundaries
(o) story boarding.

The system uses the meta-data in the following manner.

Timecode.

Timecodes are decoded, rendered into a bit-map and, in a position under control of the user, overlaid on the video window.

Log BitMap.

If the logo meta-data takes the form of a bit-map, or other graphical output format, then Video Decompression Transform Filter passes this unchanged to the Render Filter to be written directly into the video window

Logo Marker.

The logo meta-data may specify a bit-map or other graphical output format, that is to found in a specific location on the client machine on which the media player is running. In this case the bit-map is read and passed to the Render Filter.

Captioning

Captions are decoded, positioned and rendered into the video window in a manner similar to that of timecode.

Shot-Change, Video Description, Audio Description, Bookmarks, In and Out Points, GOP Boundaries.

These are examples of a generic “seek to meta-data of a specific type” operation. In and Out-Point meta-data specify the first and last frames, respectively, that the user wishes to be included in an edited clip. GOP boundary meta-data indicates the reference frames that are used by motion-compensated video compressors. Such meta-data may be useful, for example, in the case where a user wants to find an in or out-point such that a simple cut may be made to the compressed media (no re-encoding needed) in order to produce a new physical clip. Shot-change meta-data delineates regions of video which differ markedly from one another, typically where an edit or cut has been made. Video and audio description meta-data provide descriptions of the associated essence suitable for content-oriented browsing. Bookmarks are user-inserted data, possibly including some textual annotation. In all these cases the filtergraph carries out a seek operation for the meta-data of the required type. The Splitter Filter extracts the Media Time for the frame and returns it to the calling process.

Client-Targeted Information and Advertising.

The meta-data in these cases are intended for a specific audience, defined by identification data associated with, but not limited to, the media player itself, the embedding application, the operating system, the platform, or the individual machine. When the Splitter Filter finds such meta-data it is passed up to the Intrinsics module to be identified, and for the appropriate action to be performed. This may be, but is not limited to, overlaying graphics on the video window or causing a pop-up or dialogue box to be displayed.

Digital Rights Management Data.

This meta-data contains information about ownership of the media and is treated differently according to its type; it may cause informative or legal information to be displayed regarding copyright, or it may certain parts, or the entirety, of the media inaccessible.

Watermark Data.

In this case the meta-data is used as the secret message for input to a watermark generation program such as is described in Information Hiding—A Survey; Fabien A. P. Petitcolas, Ross J. Anderson and Markus G. Kuhn; proceedings IEEE, special issue on protection of multimedia content, May 1999. Because the watermark is transmitted as meta-data, rather than as part of the image data, there is no risk of the watermark degrading during the compression and decompression process, as happens if the watermark is inserted at source, prior to compression.

Conformance Data.

This meta-data describes the content in terms of its suitability for a given purpose, for example, content unsuitable for a geographic location, time of day, or age group. In this case the meta-data is passed up to the Intrinsics module to be identified, and for the appropriate action to be performed. Typically this will involve an automatic seek that has the effect of editing out all the unsuitable material.

Storyboarding

The automatic processing of the media to provide a sequence of metadata tags, which via the GUI and a set of state machines, may also be modified manually or be rule driven. These tags identify with key points of interest in the media, such that a storyboard can be built, either dynamically during playback, loading of the media clip or as part of a subsequent process. The storyboard is hence similar to the sequence of chapter headings in a DVD. Rules for storyboarding include the avoidance of black frames, marking points offset from the start of the scene for chapter identification, chapter hierarchy, etc. An example of the rules based creation of storyboard metadata might be:

Seek to scene change;

IF Scene Offset requested;
Seek Offset

While (frame==black frame)

Seek 1 frame;
Mark Storyboard

3.4 Meta-Data Agents

The Intrinsics module contains a software agent that is able to monitor the behaviour of the user and to call functions in the GUI Support Library that in turn, modify the appearance of the GUI in order to increase the efficiency of its use. In the preferred implementation, the relative frequency with which a particular seek function is called, is used to determine the priority of its position in the dialogue box that is used to choose the seek function. More generally, a software agent component maps aspects of the interactive behaviour of a user into configuration information that modifies aspects of the behaviour of the media manipulation tools.

3.5 Arthur Initialisation

Referring again to FIG. 22; the Intrinsics Module 64 governs the behaviour of the idea manipulation tools and thus must also specify the controls that are to be created and managed by the GUI Support Library. When the system is first started up, initialisation code in the GUI Support Library (65) makes a special “Query Interface” call across the interface (77) into the Intrinsics Module (64), which then returns a list specifying all the available functions. The GUI Support Library (65) uses this information to create appropriate controls (e.g. UI components such as buttons and other control icons) which, in turn, make the appropriate function calls to the Intrinsics Module (64). This scheme also ensures that new functionality easily can be incorporated into the system.

3.6 Arthur Timecode Seek Process

Referring to FIG. 23, the following describes the interactions that occur between the modules in the Media Manipulation Layer when a typical timecode seek operation is performed. The execution path for the command runs between code executing in the different modules of the invention (represented as columns).

When the user enters a timecode string into the text input box, a call (100) is generated by the GUI Support Library to the Intrinsics Module to parse the string to determine the type of command, and the arguments, if any. In the case that it is recognised as a timecode, a call (102) into the Streaming Media Support Library is made which is a request for the logical timecode value to be converted to platform-dependant “media time”. This call is translated into a platform-dependant call (103) to retrieve the media time and a result code, which is then passed back as data (105) to the Intrinsics Module. If the return code indicates an error, then this is fed back to the user through the GUI (107), otherwise the returned media time is used as a parameter in a device-independent call (106) and subsequently a device dependant call (107) into the Streaming Media Subsystem that causes the media actually to move to a new point in media time. In order that the visual feedback to the user through the video window may emphasise a chosen visual metaphor, for example film transport through an editor, the seek to the desired frame may be broken down into a sequence of smaller seeks 108, 109, 110, 111 that give a perception of moving through physical media.

3.7 Metadata Seek Process

The process of seeking to a shotchange or a bookmark are both examples of a generic operation: that of seeking the Filtergraph, based on a piece of meta-data of a specific type. Referring to FIG. 23, when the user enters a string into the text input box requesting a seek to a shot or bookmark; this is converted by the Intrinsics module into a generic “search(x)” call where x is a parameter that determines the exact meta-data to be searched for. This device-independent call (101) is converted to a device-dependant call (104) to the Streaming Media Subsystem, which causes the specific meta-data to be located. The process is then as described for the timecode seek process. A media time is returned to the Intrinsics Module which checks it and which then initiates a seek to the desired frame.

3.8 Overlaid GUI

The Render filter (55) writes the decoded pixels to the display device. It is also responsible for drawing the graphics that implement the GUI, for example, the “in” and “out” point, “make new clip”, and “bookmark” buttons. The behaviour, function and visual appearance of the GUI is controlled by the Intrinsics module which uses state machines, such as that shown in FIG. 24 to control the status of the various controls, for example, the “in” and “out” point buttons, and the “make new clip” button are only enabled at appropriate times.

3.9 Visual Feedback

Visual feedback is used to guide the user through a sequence of operations so as to ensure a process is successfully completed. As an example: in order for a ‘seek’ operation to take place the Intrinsics module sets up the GUI to allow the user to type a timecode string in hours:minutes:seconds:frames format (FIG. 3). When the “seek” button is pressed the string is checked and only if it is valid are commands passed on to the Splitter Filter which converts the input data into ‘media time’, i.e., the internal representation of time as understood by all the filtergraph modules, in order for the seek to be performed. When the operation has successfully been performed, the appearance of the string is altered (the colour changes to green) to indicate success (FIG. 4). If the string is not a legal timecode, or if a frame with the specified timecode does not exist, then the appearance of the string in the text box is modified to alert the user of an error (FIG. 6).

3.10 Output

Because of the GOP-structure of many types of media file, such as MPEG, it is impractical to maintain a physical representation of the media during editing since edit points usually will fall part-way through a GOP, requiring that new files continually need to be regenerated. Instead, each new intermediate clip that is created as editing proceeds is represented in a logical form as a particular configuration of the filtergraph. In order to output a final result, a representation of the structure of the new clip is generated using a mark-up language such as SMIL (Synchronous Multimedia Interchange Language) as illustrated in FIG. 20 and this is exported as illustrated in FIG. 15. The original media file is untouched by the editing operation; the edited version can be viewed by using the SMIL output file. If an actual physical clip of the edited material is needed then the SMIL file is used to build a filtergraph as a “dynamic transient process” 69 as shown in FIG. 22 which, when executed, generates an output file 74 by decoding, cutting, and then re-encoding the media in compressed format.

3.11 Implementation

The code for the GUI Support Library and Streaming Media Support Library is written in C++ and compiled for the Windows® operating system. The code for the platform-independent Intrinsics Module is implemented in C++ which is portable between most operating systems and platforms, but could also be written using a specification and modelling language such as UML, in which case automatic code generation tools could be used to produce the source code for a specific implementation.

4. Other Applications

The implementation described above uses the Microsoft® Windows® operating system and, as has been explained, is applicable to media player, Powerpoint®, Apple Keynote® and web application programs. These are examples of a large class of Windows® applications that use, or may potentially use, the Windows Media™ Player architecture in order to play media from within the application. Any such application that uses the media player architecture can also use the invention described above.

5. Other Platforms and Operating Systems

The implementation described above uses the Microsoft® Windows® operating system. The system may be applied by a skilled implementer to other operating systems such as Macintosh OS®, Linux, Unix®, PalmOS®, SymbianOS®, and Microsoft® Mobile.

The implementation described above uses a PC platform. The system may be applied by a skilled implementer to platforms such as IBM, Macintosh, PDA, Phone, set-top box and information/video kiosk.

1. A method of enabling an application program running on an electronic device to manipulate media, comprising the step of generating and displaying a video window associated with the application program;
characterized in that media manipulation tools, enabling an end-user to manipulate the media, are generated and deployed for any application program running on the device for which an associated video window can be generated.

2. The method of claim 1 in which the user interface components associated with the media manipulation tools are rendered in or adjacent to the video window.

3. The method of claim 1 in which the visual appearance and/or function of some or all elements of the media manipulation tools are the same across all the application programs for which an associated video window can be generated.

4. The method of claim 1 in which the media manipulation tools make use of a streaming media architecture that is common across all of the application programs.

5. The method of claim 1 in which the media manipulation tools are generated and deployed by a system that comprises:
(a) a device independent media manipulation layer; and
(b) a device independent insulation layer below the media manipulation Layer to insulate the media manipulation layer from a device specific media handling or streaming media subsystem;
(c) a device GUI abstraction layer above the media manipulation layer to insulate the media manipulation layer from the display characteristics of the specific device.

6. The method of claim 1 in which the media manipulation tools perform one or more of the following manipulations:
editing; trimming; annotating, seeking, selecting effects; transitions; re-ordering; publishing; still extraction, vector graphic alteration; create storyboard.

7. The method of claim 1 in which the device is a personal computer, a television decoder box, a personal video recorder, a personal digital assistant, a mobile telephone, a smartphone or a video kiosk.

8. The method of claim 1 in which the device is programmed with one or more of the following components to generate, deploy, display or operate the media manipulation tools:
(a) A software component that implements a cache for portions of a media file in the memory of the client machine;
(b) A software component that implements a process equivalent to a state machine, whose transitions guide a user through a sequence of interactions with a graphical user interface (GUI);
(c) A software graphics component of a GUI, that implements visual feedback to a user of the current state;
(d) A software graphics component of a GUI that implements a visual metaphor that provides a user with an intuitive understanding of the operation of the GUI;
(e) A software graphics renderer component that allows combination and/or overlay of graphical data for a GUI with pixels that are decoded from the video part of the media file and rendered into the video window.
(f) A software component that implements an export of a processed media to memory;
(g) A software component that implements the ability to read a description file(s) and construct playback in accordance with set instructions, or write such instructions from a current playback;
(h) A software component of a GUI that allows labels or triggers of various types to be added to significant parts of the media file in order to identify them as such and/or to enable seeking to these significant parts.

9. The method of claim 1 wherein the media manipulation tools allow meta data to be added to significant parts of a media file, the meta data comprising one or more of:
(a) timecode
(b) logo bit map (for example a broadcast station logo)
(c) logo marker
(d) captioning (closed caption text)
(e) shot-change
(f) video description data
(g) audio description data
(h) user-inserted bookmarks
(i) client-targeted information and advertising
(j) digital rights management data
(k) watermark data.
(l) conformance data.
(m) Edit-in and edit-out points
(n) GOP boundaries
(o) Stroyboarding

10. The method of claim 1 wherein the media manipulation tools allow triggers to be added to significant parts of a media file, the triggers comprising one or more of: initiate pop-up dialogue boxes, hold frames for a given duration, loop and messaging.

11. The method of claim 9 in which the device is programmed with a software decoder component that maps the meta-data contained in a media file to labels in the media file.

12. The method of claim 1 in which the device is programmed with a software agent component that maps aspects of the interactive behaviour of a user into configuration information that modifies aspects of the behaviour of the media manipulation tools.

13. The method of claim 1 further comprising the step of providing a media file that may be selected and played by the user, which provides instruction in the use of the media manipulation tools.

14. The method of claim 1 where the visual appearance of a GUI for the media manipulation tools is sensitive to the context in which a user of the system is working, such that the visual impact of the GUI is absent or minimised when not needed.

15. The method of claim 14 where the context in which the user of the system is working is determined by reference to the position of a screen cursor with respect to the position of the video window, such that the GUI for the media manipulation tools is only displayed and enabled after the cursor has been positioned over the video window.

16. The method of claim 1 in which the or each application program is selected from the following list of application program types:
media players, document preparation programs, help systems, web browsers, slide preparation programs, electronic mail programs, interactive learning applications, games programs, security and surveillance systems, collaborative systems, computer-aided design programs.

17. The method of claim 1 in which the media manipulation tools are deployed by a computer based system that comprises a device specific GUI abstraction layer and an underlying, separate media handling layer and/or media manipulation layer; the separation enabling different devices to be deployed with different kinds of GUI abstraction layers so that the UI components associated with the media manipulation tools appear different on these different devices, but the underlying media handling and/or media manipulation layers are common.

18. The method of claim 1 in which a representation of the structure of a new media clip generated using the media manipulation tools is generated using a mark-up language such as SMIL (Synchronous Multimedia Interchange Language).

19. The method of claim 18 in which, if an actual physical clip of the edited material is needed then the mark up language file is used to build a filtergraph as a dynamic transient process which, when executed, generates an output file by decoding, cutting, and then re-encoding the media in compressed format.

20. The method of claim 1 wherein the media manipulation layer is implemented as a plug-in component to a media player.

21. The method of claim 1 wherein the media manipulation tools appear to be intrinsic to a media player application associated with the video window.

22. A device programmed with software that, when running enables an application program to manipulate media, the software being operable to generate and display a video window associated with the application program; the device being programmed with further software that deploys media manipulation tools enabling an end-user to manipulate the media;
characterized in that the further software is operable to deploy media manipulation tools for any application program running on the device for which an associated video window can be generated.

23. The device of claim 23, in which the software and the further software, when running, enables the method of claim 1 to be performed.

24. The device of claim 22, being a personal computer, a television decoder box, a personal video recorder, a personal digital assistant, a mobile telephone, a smartphone, or a video kiosk.
